(19) United States
(12) Patent Application Publication
(10) Pub. No.: US 2009/0039014 A1
(43) Pub. Date: Feb. 12, 2009

(54) Porous Vinylidene Fluoride Resin Membrane for Water Treatment and Process for Producing the Same

(76) Inventors: Takumi Katsurao, Fukushima-Ken (JP); Tomoaki Kawakami, Chiba-Ken (JP); Toshio Hosokawa, Fukushima-Ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/630,957

(22) PCT Filed: Jun. 16, 2005
(86) PCT No.: PCT/JP2005/011049

§ 371 Date: Dec. 28, 2006

(30) Foreign Application Priority Data
Jul. 7, 2004 (JP) 2004-200936

(51) Int. Cl. B01D 71/34; B01D 69/08; C02F 1/44; B01D 67/00; B01J 20/28

(52) U.S. Cl. 210/500.23; 210/500.42; 502/4

(57) ABSTRACT

A water treatment membrane comprising a porous membrane of vinylidene fluoride resin, wherein 0.01-5 wt. parts of photocatalytic titanium oxide is uniformly dispersed in 100 wt. parts of the vinylidene fluoride resin. The water treatment membrane can solve problems accompanying the hydrophobicity of a porous membrane of vinylidene fluoride resin while taking advantage of excellent mechanical properties, weatherability, chemical resistance, etc., thereof.

### TECHNICAL FIELD

The present invention relates to a water treatment membrane of vinylidene fluoride resin used as a microfiltration membrane for removing microorganism, soiling or turbidity from potable and sewage water, for treatment of aqueous chemical liquid or for producing pure water, and a process for production thereof.

### BACKGROUND ART

As for water treatment membranes as described above, porous membranes of synthetic resins have been used hitherto. Porous membranes used as such water treatment membranes are required to satisfy various properties, such as appropriate porosity, pore size and pore size distribution suitable for removal and separation of minute particles to be removed; sufficient mechanical strengths including breaking stress, pressure resistance and elongation at break at the time of use thereof; and chemical resistance against the liquid to be treated and back-washing and ozone treatment after the use thereof.

In view of the above, conventionally developed porous membranes of polyolefin resins (e.g., described in Patent documents 1 and 2 listed below) have left a problem with respect to the chemical resistance during back washing and ozone treatment after the use thereof as separation membranes.

Vinylidene fluoride resins are excellent in weatherability, chemical resistance, heat resistance, strength, etc., and have been studied for their application to such water treatment membranes. However, while the vinylidene fluoride resins have the above-mentioned excellent properties, they do not necessarily have desirable formability because of their non-adhesiveness and poor compatibility. Moreover, as they are hydrophobic resins, the use thereof as a porous water treatment membrane is accompanied with a problem that the porous membrane is not provided with a water permeability necessary for water treatment unless it is subjected to a pre-treatment for hydrophilization with alcohol, etc., prior to the use thereof. Further, there also remains a problem of lowering in water permeability due to deposition (plugging) of organic matter contained in water to be treated.

On the other hand, porous membranes made of hydrophilic resins involve a problem that they are inferior in mechanical strengths, particularly pressure resistance, during water treatment.

In contrast to the above, in order to improve the problem accompanying the hydrophobicity of a water treatment membrane of vinylidene fluoride resin while utilizing the advantageous properties, such as strength and weatherability thereof, there has been proposed to coat the surface of a porous membrane of vinylidene fluoride resin with a hydrophilic ethylene-vinyl alcohol copolymer (Patent document 3 below). However, such an ethylene-vinyl alcohol copolymer coating does not necessarily show a good adhesion with the substrate porous membrane of vinylidene fluoride resin and also is insufficient in chemical resistance, so that the coating is liable to be lost during the continuation of use including treatments such as back washing, thus failing to retain the initial functions.

On the other hand, there has been also made a proposal of causing the outer surface and inner surface of a hollow fiber-form porous membrane of a resin, such as polypropylene, polyethylene or polysulfone, to carry a catalyst, such as titanium oxide photocatalyst, thereby capturing and decomposing microorganisms and organic foreign matter in water to be treated (Patent document 4 below). However, such a coating layer of a catalyst such as titanium oxide, involves a problem that it is liable to be lost due to continuation of water treatment, back washing, etc. Incidentally, Patent document 4 includes a description to the effect that it is possible to incorporate the catalyst directly within the material forming the hollow fiber membrane, but contains no suggestion as to how to incorporate an inorganic catalyst within a hydrophobic resin material and how to form a porous membrane therefrom.

Patent document 1: JP-B 46-40119

Patent document 2: JP-B 50-2176

Patent document 3: JP-A 2002-233739

Patent document 4: JP-A 2000-15065

### DISCLOSURE OF INVENTION

A principal object of the present invention is to provide a porous membrane of vinylidene fluoride resin for water treatment which has solved problems accompanying the hydrophobicity of a porous membrane of vinylidene fluoride resin while taking advantage of excellent mechanical properties, weatherability, chemical resistance, etc., and a process for production thereof.

Having been developed to accomplish the above object, the water treatment membrane of the present invention, comprises: a porous membrane of vinylidene fluoride resin wherein 0.01-5 wt. parts of photocatalytic titanium oxide is uniformly dispersed in 100 wt. parts of the vinylidene fluoride resin.

Further, the process for producing a porous membrane according to the present invention, comprises: uniformly mixing vinylidene fluoride resin powder and photocatalytic titanium oxide powder to form a powder mixture, mixing the powder mixture with an organic liquid material and optionally added inorganic fine powder to form a mixture, melt-extruding the mixture to form a solidified film, and extracting the organic liquid and the optionally added inorganic fine powder from the solidified film to form a porous membrane.

The present invention is based on knowledge that if a photocatalytic titanium oxide can be uniformly dispersed in hydrophobic vinylidene fluoride resin through an appropriate method to form a porous membrane, the resultant porous membrane can effectively solve the problem arising from the hydrophobicity of the vinylidene fluoride resin without being accompanied with the problems of the coating type hydrophilization, and that vinylidene fluoride resin is a best matrix material for the thus dispersed photocatalytic titanium oxide.

More specifically, while it has been known heretofore that irradiated photocatalytic titanium oxide is provided with improved hydrophilicity of the titanium oxide per se, the present inventors have found that a porous membrane of vinylidene fluoride resin with photocatalytic titanium oxide uniformly dispersed therein is also provided with hydrophilicity when irradiated in such a degree as not to require a wetting pre-treatment with ethyl alcohol, etc. (See Examples and Comparative Examples described hereinafter). Moreover, vinylidene fluoride resin not only is excellent in weatherability and chemical resistance but also has a highest level of optical transmittance, particularly high transmittance for ultraviolet rays, among fluorine-containing resins, so that the irradiation effect is well provided not only to titanium oxide particles exposed to the surface but also to titanium oxide particles embedded to at least an inner portion proximate to the surface layer. The good light resistance of vinylidene fluoride resin is also optimally utilized for the irradiation treatment. Further, as it is not a coating-type hydrophilization treatment, the problem of loss of titanium oxide coating has been remarkably alleviated, and even if the vinylidene fluoride resin is lost to some extent by back washing, etc., titanium oxide is exposed from the inner portion to the surface to sustain its effect, while the irradiation effect is, of course, expected to be attenuated with continuation of use, the hydrophilization effect of the porous membrane due to dispersion of the photocatalytic titanium oxide can be easily recovered by refreshing irradiation after taking the porous membrane out of the casing at the time of non-water treatment. Further, if the casing per se is composed of a transparent material, the irradiation can be performed during the water treatment or at a pause between the water treatments.

In order for the above-mentioned water treatment porous membrane of vinylidene fluoride resin of the present invention to be formed and exhibit the desired effects, it is necessary that the photocatalytic titanium oxide is uniformly dispersed in the vinylidene fluoride resin matrix forming the porous membrane. Localization of titanium oxide directly leads to breakage of the porous membrane during the formation thereof, thus resulting in failure to obtain a desired water treatment membrane. In other words, the uniform dispersion of the photocatalytic titanium oxide in the vinylidene fluoride resin in the present invention is satisfied by such a degree of dispersion of titanium oxide in a porous membrane formed according to a process for production thereof described hereinafter as to obviate the breakage of the membrane due to localization thereof, and a strictly defined uniformity of microscopic dispersion is not required. According to the present inventors' knowledge, melt-extrusion of a mixture of vinylidene fluoride resin powder, an organic liquid material and optionally added inorganic fine powder is necessary for the production of a porous membrane of vinylidene fluoride resin with photocatalytic titanium oxide dispersed therein, and for accomplishing the above-mentioned uniform dispersion of photocatalytic titanium oxide, it is remarkably preferred to adopt a process sequence that the vinylidene fluoride resin powder and the photocatalytic titanium oxide are first subjected to sufficient powder mixing, and then the organic liquid material and the optionally added inorganic fine powder are added and mixed therewith to form a mixture for melt-extrusion. This is the reason why the production process according to the present invention is preferably adopted for formation of the water treatment porous membrane of vinylidene fluoride resin of the present invention.

### BEST MODE FOR PRACTICING THE INVENTION

Hereinbelow, preferred embodiments of the present invention will be described in the order of steps in the process for producing water treatment porous membrane of vinylidene fluoride resin according to the present invention.

According to the process of the present invention, vinylidene fluoride resin powder and photocatalytic titanium oxide powder are uniformly mixed first of all.

(Vinylidene Fluoride Resin)

A principal membrane-forming material used in the present invention is a vinylidene fluoride resin. The vinylidene fluoride resin used in the present invention may be homopolymer of vinylidene fluoride, i.e., polyvinylidene fluoride, or a copolymer of vinylidene fluoride together with a monomer copolymerizable with vinylidene fluoride, or a mixture of these. Examples of the monomer copolymerizable with vinylidene fluoride may include: tetrafluoroethylene, hexafluoropropylene, trifluoroethylene, chlorotrifluoroethylene and vinyl fluoride, which may be used singly or in two or more species. The vinylidene fluoride resin may preferably comprise at least 70 ml % as the constituent unit. Among these, it is preferred to use homopolymer consisting of 100 mol. % of vinylidene fluoride in view of its high mechanical strength.

The vinylidene fluoride resin may preferably have a molecular weight corresponding to an inherent viscosity (referring herein to a viscosity at 30° C. of a solution at a resin concentration of 0.4 g/dl in N, N-dimethylformamide of at least 0.5 dl/g, particularly 0.8-5 dl/g.

The vinylidene fluoride resin used in the present invention may preferably be a non-crosslinked one for easiness of melt-extrusion of the composition described below, and may preferably have a melting point of 160-220° C., more preferably 170-180° C. Below 160° C., the resultant porous membrane is liable to have an insufficient heat distortion resistance, and above 220° C., the melt-mixability of the resin is lowered so that the formation of a uniform film or membrane becomes difficult. Herein, the melting point means a heat absorption peak temperature accompanying crystal melting of the resin as measured by means of a differential scanning calorimeter (DSC).

(Vinylidene Fluoride Resin Powder)

In the present invention, powder of the above-mentioned vinylidene fluoride resin obtained preferably by emulsion polymerization or suspension polymerization, particularly preferably by suspension polymerization, can be used as it is. A preferred average particle size (herein referring to 50% weight-accumulative particle diameter) of the vinylidene fluoride resin powder is on the order of 20-250 μm.

(Photocatalylic Titanium Oxide Powder)

As the photocatalytic titanium oxide powder, it is possible to use powder of titanium oxide in a form other than rutile-form titanium oxide not showing photocatalytic property, i.e., anatase-form or brookite-form titanium oxide. Each of them has a density of around 4 g/ml. As for anatase-form titanium oxide, a commercial product having an average particle size of ca. 0.1-0.3 μm is currently available (e.g., one available from Kanto Kogaku K.K.). The level of particle size is suitable to be combined with a smaller size of inorganic fine powder for promoting pore formation described hereinafter. It is generally possible to use photocatalytic titanium oxide having an average particle size of 0.001-10 μm, preferably 0.001-1 μm. As the photocatalytic titanium oxide, it is also possible to use brookite-form titanium oxide having an average primary particle size of ca. 10 nm (e.g., one available from Showa Denko K.K.), but it is undesirable to co-use the inorganic fine powder in combination with photocatalytic titanium oxide powder having an average particle size of 50 nm or below.

(Powder Mixing)

According to the process of the present invention, the above-mentioned vinylidene fluoride resin powder and photocatalytic titanium oxide powder are first subjected to powder mixing. For this purpose, it is possible to subject both powders to direct powder mixing by means of a Henschel mixer, etc., or it is possible to adopt a sequence of first dispersing the titanium oxide powder in a volatile liquid such as γ-butyrolactone, mixing therewith the vinylidene fluoride resin powder and then removing the volatile matter to form a uniform mixture of both powders consequently. In any case, if an organic liquid material or optionally added inorganic fine powder is present at the time of or prior to the mixing of both powders, the titanium oxide powder is liable to sediment because of a larger specific gravity of ca. 4 of the titanium oxide layer than the other powder(s), so that it becomes difficult to consequently obtain a porous membrane of the present invention wherein the titanium oxide is uniformly dispersed in the vinylidene fluoride resin matrix.

The photocatalytic titanium oxide may be mixed in an amount of 0.01-5 wt. parts, preferably 0.03-2 wt. parts, with 100 wt. parts of the vinylidene fluoride resin. Below 0.01 wt. part, the addition effect thereof is scarce, and in case of addition in excess of 5 wt. parts, the uniform dispersion thereof becomes difficult, thus making difficult the formation of the porous membrane.

(Mixing of Organic Liquid Material, Etc.)

Then, in the case of using both the organic liquid material and the optional inorganic fine powder, it is preferred to pre-mix them, and mixing the premix with the above-obtained powder mixture of the vinylidene fluoride resin and photocatalytic titanium oxide to form a starting mixture for formation of a porous membrane. The mixing may effected by means of, e.g., a Henschel mixer, a co-kneader or an extruder.

(Organic Liquid Material)

Herein, the term “organic liquid material” is used to inclusively mean a so-called plasticizer exhibiting a plasticizing effect without exhibiting a substantial dissolving power and also a good solvent exhibiting a dissolving power, respectively with respect to the vinylidene fluoride resin. More details thereof are as follows.

(Plasticizer)

As the plasticizer, aliphatic polyesters of a dibasic acid and a glycol may generally be used. Examples thereof may include: adipic acid-based polyesters of e.g., the adipic acid-propylene glycol type, and the adipic acid-1,3-butylene glycol type; sebacic acid-based polyesters of, e.g., the sebacic acid-propylene glycol type; azelaic acid-based polyesters of e.g., the azelaic acid-propylene glycol type, and azelaic acid-1,3-butylene glycol type; and further phthalic acid-based plasticizers, such as dibutyl phthalate and dioctyl phthalate.

(Good Solvent)

As the good solvent for vinylidene fluoride resin, those capable of dissolving vinylidene fluoride resin in a certain temperature range within 20-250° C., particularly in a temperature range of 30-160° C., may be used. Examples thereof may include: N-methylpyrrolidone, dimethylformamide, dimethylacetamide, dimethyl sulfoxide, methyl ethyl ketone, acetone, tetrahydrofuran, dioxane, ethyl acetate, propylene carbonate, cyclohexane, methyl isobutyl ketone, dimethyl phthalate, and solvent mixtures of these.

The organic liquid material including a plasticizer and a good solvent for vinylidene fluoride resin is removed by extraction after the formation of a film by melt-extrusion, thereby promoting the formation of pores necessary for a porous membrane, but the manners of use thereof are versatile, including principally the following three cases.

(a) Case of Using a Plasticizer Alone

In this case, it is preferred to use a plasticizer as mentioned above in an amount of 50-300 wt. parts, per 100 wt. parts of vinylidene fluoride resin, preferably in combination with inorganic fine powder described hereinafter for promoting the pore formation. (A process according to JP-A 58-93734).

(b) Case of Using a Plasticizer and a Good Solvent in Combination

In this case, it is preferred to mix 70-240 wt. parts of a plasticizer and 5-80 wt. parts of a good solvent (so as to provide a total amount of 100-250 wt. parts together with the plasticizer) with 100 wt. parts of vinylidene fluoride resin. In this case, the good solvent has a function of helping the uniform mixing of the vinylidene fluoride resin and the plasticizer used for formation of pores by removal thereof, but the addition thereof in an excessive amount rather obstructs the pore-forming function of the plasticizer. (A process according to WO-A 2004/081109).

(c) Case of Using a Solvent Having a Relatively Low Dissolving Power as a Principal Component.

A solution formed by dissolving vinylidene fluoride resin at a concentration of 5-35 wt. % in a liquid principally comprising a liquid, such as dimethyl sulfoxide, which is a solvent for vinylidene fluoride resin but showing a relatively low dissolving power thereto, is extruded into a solidifying liquid principally comprising water to be solidified. (A process according to JP-B 7-8548). In this process, a small amount of a non-solvent, such as water or an alcohol (e.g., glycerin) is preferably added to the above-mentioned solvent so as to control the pore distribution of the resultant porous membrane.

(Inorganic Fine Powder)

In the case (a) above, it is preferred to co-use inorganic fine powder in addition to the plasticizer. As the inorganic fine powder, colloidal silica, alumina, aluminum silicate, calcium silicate, etc., may be used, and particularly one having a particle size which is essentially smaller than that of the titanium oxide, preferably at most ½, more preferably at most ⅕, of the latter, may be used. Such a smaller particle size is used so that the added inorganic fine powder is dissolved to be removed preferentially to the photocatalytic titanium oxide during a final treatment with an alkaline aqueous solution.

(Mixing and Melt-Extrusion)

The above-mentioned starting mixture may be extruded into a film by extrusion through an annular nozzle or a T-die at a temperature of 140-270° C., preferably 150-270° C. (at most 100° C. in the above case (a)). According to a preferred embodiment for obtaining such a mixture, a twin-screw kneading extruder is used, and the powder mixture of the vinylidene fluoride resin and the photocatalytic titanium oxide is supplied from an upstream side of the extruder and the mixture of the organic liquid material and the optionally added inorganic fine powder is supplied at a downstream position to be formed into a uniform mixture until they pass through the extruder and are discharged. The twin-screw extruder may be provided with a plurality of blocks capable of independent temperature control along its longitudinal axis so as to allow appropriate temperature control at respective positions depending on the contents of the materials passing therethrough.

(Cooling)

In the process of the present invention, the melt-extruded film product is preferably cooled and solidified from one surface. As for a flat sheet product extruded through a T-die, the cooling may be performed by causing the sheet to contact a surface temperature-controlled cooling drum or roller, and as for a hollow fiber film extruded through a nozzle, the cooling may be effected by causing the film to path through a cooling medium, such as water. The temperature of the cooling drum, etc., or cooling medium can be selected from a broad temperature range of 5-120° C. but may preferably be in a range of 10-100° C., particularly preferably 30-80° C.

(Extraction)

The cooled and solidified film product is then introduced into an extraction liquid bath to remove the plasticizer and the good solvent therefrom. The extraction liquid is not particularly restricted provided that it does not dissolve the vinylidene fluoride resin while dissolving the plasticizer and the good solvent. Suitable examples thereof may include: polar solvents having a boiling point on the order of 30-100° C., inclusive of alcohols, such as methanol and isopropyl alcohol, and chlorinated hydrocarbons, such as dichloromethane and 1,1,1-trichloroethane. Further, in the above case (a), a further treatment with an alkaline aqueous solution is performed in order to remove the added inorganic fine powder by extraction. Further, in the above case (c), a small amount of a low-dissolving power solvent, such as dimethyl sulfoxide, similar to the one included in the starting mixture may be added to water as the solidifying liquid to promote the extraction.

(Post-Treatment)

In the above-described manner, it is possible to obtain a water treatment porous membrane of vinylidene fluoride resin according to the present invention wherein photocatalytic titanium oxide is uniformly dispersed therein.

However, it is also preferred to further subject the water treatment porous membrane to a stretching treatment after heat-treatment at, e.g., 80-160° C., as desired, in order to increase the porosity and the pore size and to increase the strength and elongation of the porous membrane. The stretching may be effected as biaxial stretching by tentering or uniaxial stretching in the longitudinal direction of the porous membrane as by a pair of rollers rotating at different peripheral speeds, at a stretching ratio of ca. 1.2-4.0 times, for example.

A further increased water permeability can be attained by subjecting the porous membrane after the stretching to a treatment with an elution liquid, such as an alkaline liquid, an acid liquid or a liquid for extracting the plasticizer.

(Porous Membrane of Vinylidene Fluoride Resin)

The porous membrane of vinylidene fluoride resin of the present invention obtained as described above may be generally provided with properties, inclusive of a porosity of 55-90%, preferably 60-85%, particularly preferably 65-80%; a tensile strength of at least 5 MPa, an elongation at break of at least 5%, and when used as a water-filtering membrane, a water permeation rate of at least 5 m³/m²·day at 100 kPa. The thickness is ordinarily in the range of 5-800 μm, preferably 50-600 μm, particularly preferably 150-500 μm. In the case of a hollow fiber form, the outer diameter may suitably be on the order of 0.3-3 mm, particularly ca. 1-3 mm.

### EXAMPLES

Hereinbelow, the present invention will be described more specifically based on Examples and Comparative Examples. The properties described herein including those described below are based on measured values according to the following methods.

(Porosity)

The length and also the width and thickness (or outer diameter and inner diameter in the case of a hollow fiber) of a sample porous membrane were measured to calculate an apparent volume V (cm³) of the porous membrane, and the weight W (g) of the porous membrane was measured to calculate a porosity according to the following formula:

Porosity(%)=(1−W/(V×ρ))×100,

wherein ρ: density of PVDF (=1.78 g/cm³)

### Example 1

### Preparation of Hollow Fiber Membrane

100 wt. parts of vinylidene fluoride polymer (PVDF) having an inherent viscosity of 1.0 dl/g (“KF#1000”, made by Kureha Kagaku K.K.) and 0.5 wt. part of anatase-form titanium oxide (TiO₂) (made by Kanto Kagaku K.K.; average particle size=0.1-0.3 μm) were mixed with each other in a 2 liter-Henschel mixer to form Mixture A. Then, 23 wt. parts of hydrophobic silica (“AEROSIL R-972”, made by Nippon Aerosil K.K.), 30.8 wt. parts of dioctyl phthalate (DOP) and 6.2 wt. parts of dibutyl phthalate (DBP) were mixed in a 2 liter-Henschel mixer, and Mixture A was further added thereto and mixed therewith in weight ratios of PVDF:TiO₂:DOP:DBP:AEROSIL=40:0.2:30.8:6.2:23.

The above mixture was fed to a laboratory extruder equipped with a hollow fiber nozzle (“PPKR-mini”, made by Imoto Seisakusho K.K.) and extruded into a hollow fiber-form to prepare a hollow fiber membrane precursor.

The above hollow fiber membrane precursor was subjected to three times of immersion for 1 hour in methylene chloride to extract DOP and DBP and then dried in air at 60° C. Then, the membrane was immersed for 30 min. in 50 vol. %-EtOH aqueous solution and further transferred to be immersed in water for 30 min. to wet the hollow fiber membrane. Then, the membrane was immersed two times of immersion for 1 hour in 5 wt. %-NaOH aqueous solution to extract the hydrophobic silica, followed by 12 hours of washing with hot water at 60° C. and drying at 60° C. to obtain Hollow fiber membrane B having an inner diameter of 0.7 mm, an outer diameter of 1.3 mm and a porosity of 70%. Incidentally, each step of immersion was performed under application of ultrasonic vibration.

The above-formed Hollow fiber membrane B was subjected to 4 hours of irradiation from a ca. 40 cm-distant fluorescent lamp for insect collector (“EL15BA-37•K”, made by Matsushita Denki Sangyo K.K.) (having a spectral intensity distribution including a sharp spectral intensity peak at a wavelength of ca. 370 nm and intensities decreasing linearly toward a lower limit wavelength of 300 nm and an upper limit wavelength of 500 nm, respectively) to provide Hollow fiber membrane A (inner diameter 0.7 mm/outer diameter 1.3 mm).

According to measurement by ICE-AES (inductively coupled plasma-Auger electron spectroscopy), the hollow fiber membrane precursor before the extraction with methylene chloride in the hollow fiber membrane production process exhibited a titanium oxide content of 0.498 wt. % showing a good agreement with the value in the starting mixture, and the content in Hollow fiber membrane A after the extraction was 0.461 wt. % showing a very slight loss during the extraction step.

### Reference Example 1

Hollow fiber membrane B (inner diameter 0.7 mm/outer diameter 1.3 mm) not subjected to the photo-irradiation was used as it was.

### Comparative Example 1

Hollow fiber membrane C (inner diameter 0.7 mm/outer diameter 1.3 mm) was prepared in the same manner as in Example 1 except for omitting the mixing of the titanium oxide.

### Comparative Example 2

0.2 wt. % of anatase-form titanium oxide (made by Kanto Kagaku K.K., 0.1-0.3 μm), 23 wt. % of hydrophobic silica (“AEROSIL R-972”), 30.8 wt. % of dioctyl phthalate (DOP) and 6.2 wt. % of dibutyl phthalate (DBP) were mixed in a 2 liter-Henschel mixer, and 40 wt. % of vinylidene fluoride polymer (“KF#1000”, made by Kureha Kagaku K.K.) was added thereto and further mixed therewith. The thus-obtained mixture was fed to a laboratory extruder equipped with a hollow fiber nozzle (“PPKR-mini”, made by Imoto Seisakusho K.K.) for trying to produce a hollow fiber membrane precursor in the same manner as in Example 1, whereas severance of hollow fiber occurred frequently, thus failing in the formation.

The hollow fiber membranes of Example 1, Reference Example 1 and Comparative Example 1 that could be formed in the above Examples were subjected to the following measurement of water permeation rates to determine a water permeation rate after ethanol treatment PWF, a water permeation rate without ethanol treatment PWF_{noEtOH}, and a ratio between them PWF_{noEtOH}/PWF, respectively.

(Measurement of Water Permeation Rates)

A prepared hollow fiber membrane (sample) was cut into a constant length (including a measurement length of 800 mm and 50 mm at each end for protrusion out of the measurement vessel) and fixed to a phenolic resin made-holder for measurement of water permeation rate with epoxy resin (“ARALDITE RAPID”, made by Showa Kobunshi K.K.), and then the membrane was hydrophilized with 100% ethanol. Then, the phenolic resin-made holder was attached to the measurement vessel (made by K.K., Alpha Machine). After passing 200 ml of water at an outer pressure of 0.025 MPa for removing the ethanol, amounts of permeated pure water were measured for 10 min. each at outer pressures of 0.025, 0.05 and 0.1 MPa to calculate pure water permeation rates at 25° C. with reference to a temperature-calibration table. An outer surface area was determined from the measured inner and outer diameters, and based thereon, a water permeation rate (PWF) (m³/m²·day) was calculated per unit outer surface area (m²) and time (day).

On the other hand, the above operation was repeated without hydrophilization of the membranes with 100% ethanol to similarly determine pure water permeation rates, which were identified as PWF_{noEtOH}.

TABLE 1

| | Sample | | | | |
|---|---|---|---|---|---|
| | Hollow fiber | Photo- | PWF | PWF_{noEtOH} | PWF_{noEtOH}/ |
| Example | membrane | irradiation | [(m³/(m² · day)] | [(m³/(m² · day)] | PWF (%) |
| 1 | A (with TiO₂) | yes | 52 | 36 | 69 |
| Ref. 1 | B (with TiO₂) | no | 53 | 0.95 | 1.8 |
| Comp. 1 | C (no TiO₂) | no | 50 | 0.68 | 1.4 |

The contents of titanium oxide in Hollow fiber membrane A were measured according to ICP-AES before and after the measurement of water permeation rates, whereby the values of 0.461 wt. % before the measurement and 0.462 wt. % after the measurement were given, so that no decrease at all of the TiO₂ content due to water permeation was confirmed.

### INDUSTRIAL APPLICABILITY

From the results shown in the above Table 1, it is understood that a water treatment porous membrane of vinylidene fluoride resin containing TiO₂ uniformly dispersed therein and subjected to photo-irradiation (Example 1) exhibited a remarkably larger PWF_{noEtOH}/PWF ratio than a water treatment membrane containing TiO₂ but not subjected to photo-irradiation (Reference Example 1) and a water treatment membrane containing no TiO₂ (Comparative Example 1), so that it has been provided with remarkably improved hydrophilicity without effecting a troublesome wetting pretreatment with ethanol and allows a start of water treatment directly from a dry state.

1. A water treatment membrane comprising a porous membrane of vinylidene fluoride resin, wherein 0.01-5 wt. parts of photocatalytic titanium oxide is uniformly dispersed in 100 wt. parts of the vinylidene fluoride resin.

2. A water treatment membrane according to claim 1, wherein the photocatalytic titanium oxide is anatase-form titanium oxide or brookite-form titanium oxide.

3. A water treatment membrane according to claim 1, wherein the photocatalytic titanium oxide is anatase-form titanium oxide having an average particle size of 0.001-10 μm.

4. A water treatment membrane according to claim 1, wherein the vinylidene fluoride resin has an inherent viscosity of at least 0.5 dl/g and a melting point of 160-220° C. and having been obtained through emulsion polymerization or suspension polymerization.

5. A water treatment membrane according to claim 1, in the form of a hollow fiber membrane.

6. A water treatment membrane according to claim 5, having an outer diameter of 0.3-3 mm and a porosity of 55-90%.

7. A water treatment membrane according to claim 1, having been irradiated with ultraviolet rays.

8. A process for producing a water treatment membrane according to claim 1, comprising:
uniformly mixing vinylidene fluoride resin powder and photocatalytic titanium oxide powder to form a powder mixture,
mixing the powder mixture with an organic liquid material and optionally added inorganic fine powder to form a mixture,
melt-extruding the mixture to form a solidified film, and
extracting the organic liquid and the optionally added inorganic fine powder from the solidified film to form a porous membrane.

9. A production process according to claim 8, wherein the vinylidene fluoride resin powder subjected to the powder mixing has an average particle size of 20-250 μm, and the photocatalytic titanium oxide powder comprises anatase powder having an average particle size of 0.001-10 μm.

10. A production process according to claim 9, wherein inorganic fine powder having an average particle size which is at most ½ of that of the photocatalytic titanium oxide is further mixed with the powder mixture to form the mixture for melt-extrusion.

11. A production process according to claim 8, wherein the organic liquid material comprises a plasticizer for vinylidene fluoride resin.

12. A production process according to claim 8, wherein the organic liquid material comprises a plasticizer and a good solvent for vinylidene fluoride resin.

13. A production process according to claim 9, wherein the organic liquid material is a solvent showing a low dissolving power to vinylidene fluoride resin and the solidified film is formed by introducing a heated 5-35 wt. % solution of vinylidene fluoride resin in the solvent into a solidifying liquid principally comprising water.

14. A production process according to claim 8, further including a step of stretching the formed porous membrane.

15. A production process according to claim 8, further including a step of irradiating the formed porous membrane with ultraviolet rays.
